(19) United States
(12) Patent Application Publication
(10) Pub. No.: US 2013/0212532 A1
(43) Pub. Date: Aug. 15, 2013

(54) ELECTRONIC DEVICE AND METHOD FOR UNLOCKING TOUCH SCREENS

(71) Applicant: HSING-CHUN HSIEH, Shindian (TW)

(72) Inventor: HSING-CHUN HSIEH, Shindian (TW)

(73) Assignee: FIH (HONG KONG) LIMITED, Kowloon (HK)

(21) Appl. No.: 13/457,923

(22) Filed: Apr. 27, 2012

(30) Foreign Application Priority Data
Feb. 10, 2012 (TW) 101104464

(51) Int. Cl. G06F 3/048; G06F 3/041

(52) U.S. Cl. 715/833

(57) ABSTRACT

An electronic device and a method uses to unlock touch screens. A first icon is displayed on a locked touch screen. The first icon randomly moves on the touch screen. A second icon is displayed on the touch screen when the touch screen is touched. The touch screen is unlocked when the second icon is made to touch the first icon.

### BACKGROUND

1. Technical Field

Embodiments of the present disclosure relate to user interfaces that employ touch-sensitive displays, and more particularly to unlocking of touch screens on portable electronic devices.

2. Description of Related Art

Touch screens are popular for use as displays and user input devices on portable devices, such as mobile telephones and personal digital assistants (PDAs). One problem associated with using the touch screens on the portable devices is the unintentional activation or deactivation of functions due to unintentional contact with the touch screens. Thus, the touch screens on such devices, and/or applications running on such devices may be locked upon satisfaction of predefined lock conditions, such as ending an active call, or after a predetermined time of idleness has elapsed, or upon manual locking by a user.

Devices with the touch screens and/or applications running on such devices may be unlocked by any of several well-known unlocking procedures, such as pressing a predefined set of buttons (simultaneously or sequentially) or entering a code or password. These unlock procedures, however, have drawbacks. The button combinations may be hard to perform. Creating, memorizing, and recalling passwords, codes, and the like can be burdensome. These drawbacks may reduce the ease of use of the unlocking process and, as a consequence, the ease of use of the device in general.

### BRIEF DESCRIPTION OF THE DRAWINGS

FIG. 1 is a block diagram of one embodiment of an electronic device including an unlocking system.

FIG. 2 is a block diagram of one embodiment of function modules of the unlocking system in FIG. 1.

FIGS. 3A-3C illustrate a flowchart of one embodiment of a method for unlocking touch screens.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

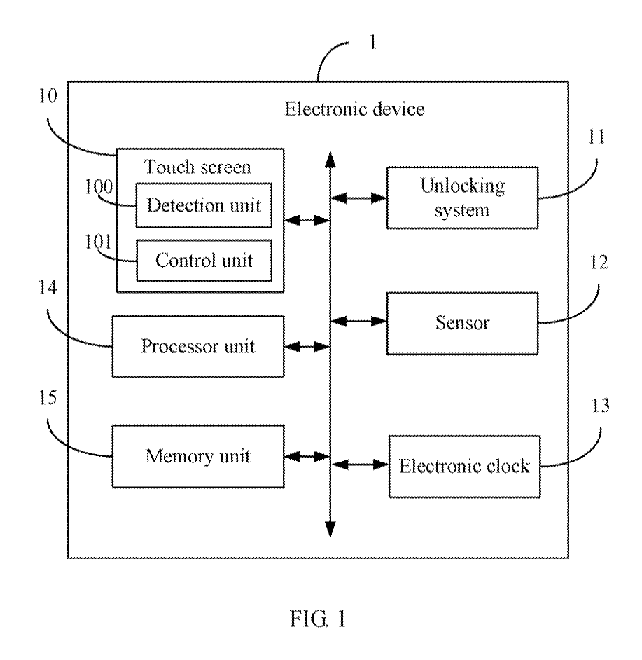

FIG. 1 is a block diagram of one embodiment of an electronic device 1 including an unlocking system 11. The electronic device 1 may be a smart phone, a computer, or a personal digital assistant (PDA), for example, which is installed with a touch screen 10. The touch screen 10 includes a detection unit 100 and a control unit 101. The detection unit 100 detects the presence and location information of a touch within a display area on the touch screen 10, and sends the location information of the touch to the control unit 101. The control unit 101 generates data as to the coordinates of the touch and then sends the coordinate to the unlocking system 11.

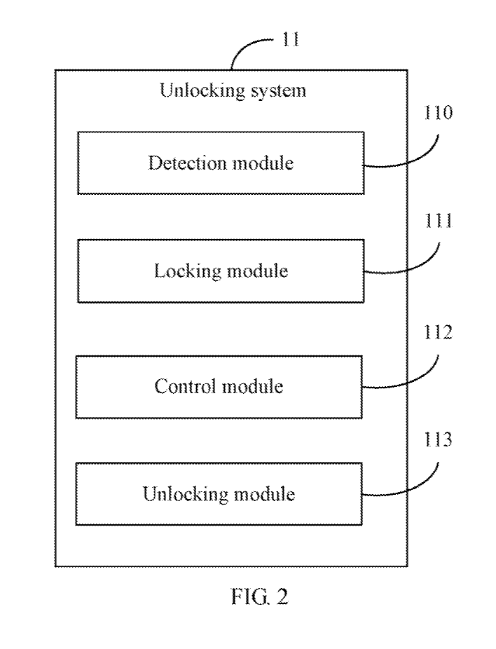

The unlocking system 11 includes a plurality of function modules (see FIG. 2 below), which include computerized code when executed to provide a method of unlocking the touch screen 10 by pressing a randomly movable unlocking icon.

The electronic device 1 further includes a sensor 12. After being locked, the touch screen 10 may enter into a sleep mode after a predetermined time of inactivity has elapsed. The sensor 12 detects whether a waking condition of the touch screen 10 is triggered when the touch screen 10 is in the sleep mode. After the waking condition is triggered, the touch screen 10 enters a working mode. The waking condition may be that a predetermined physical button of the electronic device 1 is pressed, for example. The electronic device 1 may further include an electronic clock 13 for timing.

In addition, the electronic device 1 includes a processor unit 14. The processor unit 14 may include a processor, a microprocessor, an application-specific integrated circuit (ASIC), and a field programmable gate array (FPGA), for example. The processor unit 14 may execute the computerized code of the function modules of the unlocking system 11 to realize functions of the unlocking system 11.

Furthermore, the electronic device 1 includes a memory unit 15. The memory unit 15 may include any type(s) of non-transitory computer-readable storage medium, such as a hard disk drive, a compact disc, a digital video disc, or a tape drive. The memory unit 15 stores the computerized code of the function modules of the unlocking system 11.

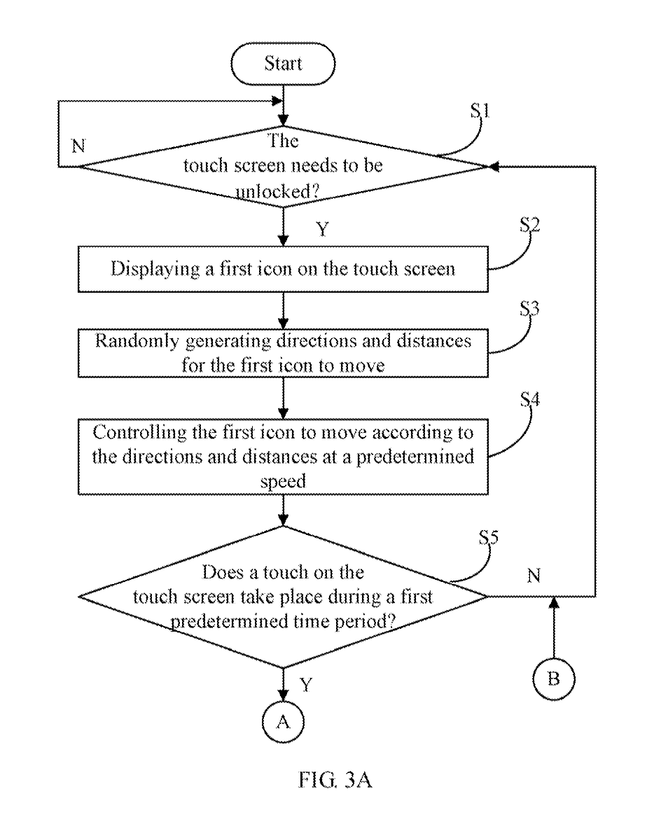

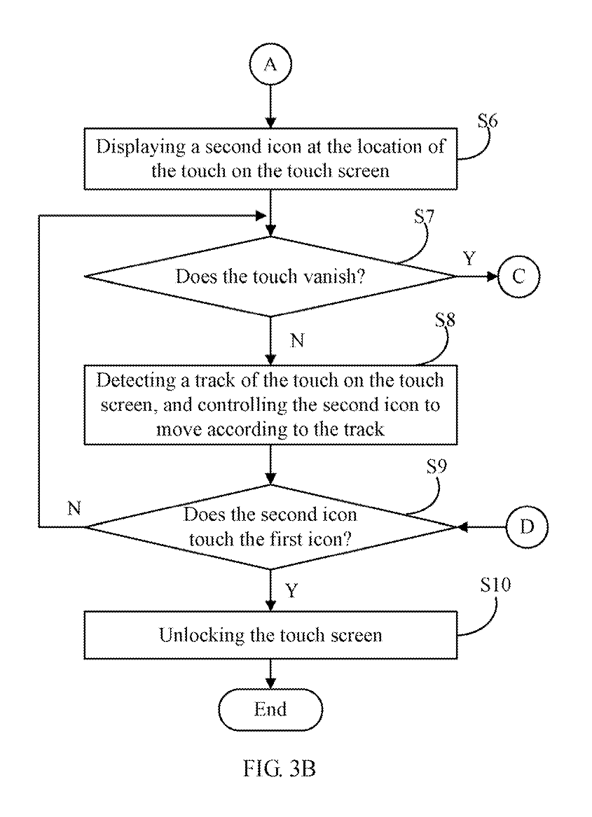

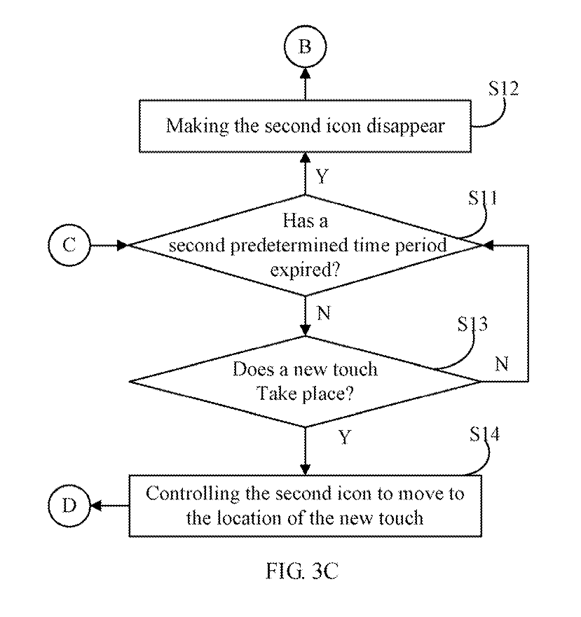

FIG. 2 is a block diagram of one embodiment of the function modules of the unlocking system 11. In one embodiment, the function modules may include a detection module 110, a locking module 111, a control module 112, and an unlocking module 113. The functions of the function modules 110-113 are illustrated in FIG. 3 and described below.

FIGS. 3A-3C illustrate a flowchart of one embodiment of a method for unlocking touch screens. Depending on the embodiment, additional steps may be added, others removed, and the ordering of the steps may be changed.

In step S1, the detection module 110 determines whether the touch screen 10 which is locked needs to be unlocked. In one embodiment, when the sensor 13 detects that the waking condition of the touch screen 10 is triggered, the sensor 13 may send a trigger signal to the detection module 110. The detection module 110 determines the touch screen 10 needs to be unlocked after receiving the trigger signal, and then, step S2 is implemented. Until a trigger signal is received, step S1 is repeated.

In step S2, locking module 111 displays a first icon on the touch screen 10. The first icon is an unlocking icon, and is represented by a picture of an object, an animal, or a plant, for example.

In step S3, the locking module 111 randomly generates different directions and distances for the first icon to move. The different directions and distances may include moving upwards by 5 centimeter (cm), and moving leftwards by 2 cm, and then moving downwards by 3 cm, for example.

In step S4, the control module 112 controls the first icon to move according to the directions and distances at a predetermined speed. The predetermined speed may be, for example, 1 cm per second.

In step S5, the unlocking module 113 determines whether a touch on the touch screen takes place during a first predetermined time period. The touch may be made by a fingertip, or a stylus, for example. In one embodiment, the first predetermined time period may be 1 minute, and begins at the time of the first icon being initially generated. For example, when the first icon is generated at 9:00, the first predetermined time period may be from 9:00 to 9:01. As mentioned, the detection unit 100 of the touch screen 10 detects the presence and location information of a touch within a display area on the touch screen 10, and the control unit 101 of the touch screen 10 generates data as to the coordinates of the touch, and then sends the coordinates to the unlocking system 11. The unlocking module 113 determines that a touch has taken place when receiving the data as to coordinates during the first predetermined time period, and then step S6 is implemented. Until a touch takes place, steps S1 to S5 are repeated.

In step S6 (FIG. 3B), the unlocking module 113 displays a second icon at the location of the touch on the touch screen 10. Corresponding to the first icon, the second icon may be also represented by a picture of an object, an animal, or a plant. For example, when the first icon is represented by a picture of a lock, the second icon may be represented by a picture of a key, when the first icon is represented by a picture of a fly, the second icon may be represented by a picture of a flyswatter, or when the first icon is represented by a picture of a tree, the second icon may be represented by a picture of a spade.

In step S7, the unlocking module 113 determines whether the touch is no longer present on the touch screen 10. Step S8 is implemented when the touch is still present on the touch screen 10. Otherwise, step S11 (FIG. 3C) is implemented when the touch is no longer present on the touch screen 10.

In step S8, the unlocking module 113 detects a movement track of the touch on the touch screen 10, and controls the second icon to move according to the movement track. The movement track of the touch is generated when the touch is dragged across screen 10.

In step S9, the unlocking module 113 determines whether the second icon touches the first icon. Step S10 is implemented when the second icon touches the first icon, or step S7 is repeated when the second icon does not touch the first icon.

In step S10, the unlocking module 113 unlocks the touch screen 10.

In step S7, when the unlocking module 113 determines that the touch is no longer present on the touch screen 10, step S11 is implemented, the unlocking module 113 further determines whether a second predetermined time period has expired. The second predetermined time period may be 1 minute for example, and begins at the time of the touch being no longer present on the touch screen 10. Step S12 is implemented when the second predetermined time period has expired, and step S13 is implemented when the second predetermined time period has not expired.

In step S12, the unlocking module 113 makes the second icon disappear, and then step S1 is repeated.

In step S13, the unlocking module 113 determines whether a new touch takes place on the touch screen 10. Step S11 is repeated when no new touch takes place, and step S14 is implemented when a new touch takes place.

In step S14, the unlocking module 113 controls the second icon to move to the location of the new touch, and then, step S9 is implemented.

As seen, in the above embodiment, the second icon is still displayed on the touch screen 10 after the touch is no longer present on the touch screen 10 until the second predetermined time period has expired. In other embodiment, the second icon may disappear as soon as the touch is no longer present on the touch screen 10, and reappear when the new touch takes place during the second predetermined time period.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for unlocking touch screens being performed by execution of computerized codes by a processor of an electronic device, the method comprising:
displaying a first icon on a touch screen which is locked, and randomly generating directions and distances for the first icon to move;
controlling the first icon to move according to the directions and distances;
displaying a second icon on the touch screen when a touch takes place on the touch screen; and
unlocking the touch screen when the second icon touches the first icon.

2. The method according to claim 1, before displaying the first icon, the method further comprising:
determining whether the touch screen needs to be unlocked according to whether a waking condition of the touch screen is triggered.

3. The method according to claim 1, before displaying the second icon on the touch screen, the method further comprising:
determining whether the touch takes place during a first predetermined time period which begins at the time of the first icon being generated, to determine whether to display the second icon or not.

4. The method according to claim 1, wherein the second icon still displays on the touch screen after the touch is no longer present on the touch screen until a second predetermined time period has expired, the second predetermined time period beginning from the touch being no longer present on the touch screen.

5. The method according to claim 1, wherein the second icon disappears as soon as the touch is no longer present on the touch screen, and reappears when a new touch takes place on the touch screen during a second predetermined time period which begins from the touch being no longer present on the touch screen.

6. The method according to claim 1, wherein the first icon and the second icon are represent by pictures of objects, animals, or plants.

7. A electronic device, comprising:
a non-transitory storage medium;
at least one processing unit; and
one or more modules that are stored in the non-transitory storage medium; and are executed by the at least one processing unit, the one or more modules comprising instructions to:
display a first icon on a touch screen which is locked, and randomly generating directions and distances for the first icon to move;
control the first icon to move according to the directions and distances;
display a second icon on the touch screen when a touch takes place on the touch screen; and
unlock the touch screen when the second icon touches the first icon.

8. The electronic device according to claim 7, further comprising a sensor that detects a trigger of a waking condition of the touch screen when the touch screen is in a sleep mode.

9. The electronic device according to claim 8, wherein the one or more modules further comprises instructions to:
determine whether the touch screen needs to be unlocked according to whether a waking condition of the touch screen is triggered.

10. The electronic device according to claim 7, wherein the one or more modules further comprises instructions to:
determine whether the touch takes place during a first predetermined time period which begins at the time of the first icon being generated, to determine whether to display the second icon.

11. The electronic device according to claim 7, wherein the second icon still displays on the touch screen after the touch is no longer present on the touch screen until a second predetermined time period has expired, the second predetermined time period beginning from the touch is no longer present on the touch screen.

12. The electronic device according to claim 7, wherein the second icon disappears as soon as the touch is no longer present on the touch screen, and reappears when a new touch takes place on the touch screen during a second predetermined time period which begins from the touch being no longer present on the touch screen.

13. The electronic device according to claim 7, wherein the first icon and the second icon are represent by pictures of objects, animals, or plants.

14. A non-transitory storage medium having stored thereon instructions that, when executed by a processor of an electronic device, causes the processor to perform a method for unlocking touch screens, wherein the method comprises:
displaying a first icon on a touch screen which is locked, and randomly generating directions and distances for the first icon to move;
controlling the first icon to move according to the directions and distances;
displaying a second icon on the touch screen when a touch takes place on the touch screen; and
unlocking the touch screen when the second icon touches the first icon.

15. The storage medium according to claim 14, before displaying the first icon, the method further comprising:
determining whether the touch screen needs to be unlocked according to whether a waking condition of the touch screen is triggered.

16. The storage medium according to claim 14, before displaying the second icon on the touch screen, the method further comprising:
determining whether the touch takes place during a first predetermined time period which begins at the time of the first icon being generated, to determine whether to display the second icon or not.

17. The storage medium according to claim 14, wherein the second icon still displays on the touch screen after the touch is no longer present on the touch screen until a second predetermined time period has expired, the second predetermined time period beginning from the touch being no longer present on the touch screen.

18. The storage medium according to claim 14, wherein the second icon disappears as soon as the touch is no longer present on the touch screen, and reappears when a new touch takes place on the touch screen during a second predetermined time period which begins from the touch being no longer present on the touch screen.

19. The storage medium according to claim 14, wherein the first icon and the second icon are represent by pictures of objects, animals, or plants.
